(19) United States
(12) Patent Application Publication
(10) Pub. No.: US 2011/0113465 A1
(43) Pub. Date: May 12, 2011

(54) METHOD AND SYSTEM FOR IDENTIFYING SET-TOP BOX IN DOWNLOAD CONDITIONAL ACCESS SYSTEM

(75) Inventors: Seong Min JOE, Yongin-si (KR); Jae Jin SHIN, Seoul (KR)

(73) Assignee: SAMSUNG ELECTRONICS CO. LTD., Suwon-si (KR)

(21) Appl. No.: 12/941,175

(22) Filed: Nov. 8, 2010

(30) Foreign Application Priority Data
Nov. 11, 2009 (KR) 10-2009-0108536

(51) Int. Cl. H04N 7/173

(52) U.S. Cl. 725/132

(57) ABSTRACT

A set-top box identification method and system for identifying the set-top box which is currently connected to a Downloadable Conditional Access System (DCAS) based on set-top box manufacturer and/or set-top box model are provided. The set-top box identification method for the DCAS includes retrieving set-top box type information upon receipt of a set-top box information request transmitted by a DCAS headend, transmitting the set-top box information including the set-top box type information to the DCAS headend, and identifying, at the DCAS headend, the set-top box based on the set-top box information. The DCAS headend can acquire the information on the connected set-top box at any time and determine the manufacturer and model of the set-top box from the set-top box information.

### PRIORITY

This application claims the benefit under 35 U.S.C. §119(a) of a Korean patent application filed on Nov. 11, 2009 in the Korean Intellectual Property Office and assigned Serial No. 10-2009-0108536, the entire disclosure of which is hereby incorporated by reference.

### BACKGROUND OF THE INVENTION

1. Field of the Invention

The present invention relates to a Downloadable Conditional Access System (DCAS). More particularly, the present invention relates to a method and system for identifying a set-top box which is currently connected to the DCAS based on a set-top box manufacturer and/or a set-top box model.

2. Description of the Related Art

A Conditional Access System (CAS) is a conditional access control system to protect contents from the access of a user who is not subscribed to a specific cable broadcast service. The CAS is capable of interoperating with a subscriber management system to provide various programs in the form of a package, Video On Demand (VOD), or Pay Per View (PPV) service in consideration of the tastes of subscribers. In addition, the CAS can perform billing on the subscribed programs per subscriber.

Conventionally, the CAS interoperates with a cable card in a set-top box. However, since the CAS operates in different manners according to the manufacturer of the set-top box and undergoes system dependency problems with the cable card, conventional set-top boxes only support a specific CAS and are incapable of a change of the CAS.

In order to overcome these problems, a Downloadable Conditional Access System (DCAS) has been proposed. The DCAS is a download authentication technology which is capable of supplying a pay service by allowing the set-top box to download software CAS. DCAS is advantageous for the cable operator to freely update the CAS installed in the set-top box.

The CAS update of a set-top box in DCAS is performed in such a manner that the set-top box accesses a DCAS network by means of a Security Processor installed in the set-top box and downloads a Conditional Access image for updating the CAS from the headend of the DCAS automatically.

In the conventional DCAS, the headend of the DCAS does not have a function for determining the product type and model of the set-top box attempting access to the network and thus cannot acquire the information about the types of a Secure Micro (SM) boot loader and CAS client that are differently applied depending on the set-top box. This may cause the set-top box to download an inappropriate CAS, resulting in failure of broadcast service to valid subscribers.

Therefore, a need exists for a method and an apparatus for identifying a set-top box in a DCAS that is capable of preventing the set-top box from downloading appropriated CAS.

### SUMMARY OF THE INVENTION

An aspect of the present invention is to address the above-mentioned problems and/or disadvantages and to provide at least the advantages described below. Accordingly, an aspect of the present invention is to provide a method and an apparatus for identifying a set-top box in a Downloadable Conditional Access System (DCAS) that is capable of preventing the set-top box from downloading appropriated Conditional Access System (CAS).

In accordance with an aspect of the present invention, a method for identifying a set-top box in a DCAS is provided. The method includes retrieving set-top box type information upon receipt of a set-top box information request transmitted by a DCAS headend, transmitting the set-top box information including the set-top box type information to the DCAS headend, and identifying, at the DCAS headend, the set-top box based on the set-top box information.

In accordance with another aspect of the present invention, a set-top box identification system for a DCAS includes a DCAS headend which requests for set-top box information, and a set-top box which retrieves the set-top box information and transmits the set-top box information including set-top box type information to the DCAS headend in response to the request from the DCAS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description in conjunction with the accompanying drawings, in which:

FIG. 1 is a signaling diagram illustrating operations of entities of a Downloadable Conditional Access System (DCAS) according to an exemplary embodiment of the present invention;

FIG. 2 is a block diagram illustrating a configuration of a set-top box according to an exemplary embodiment of the present invention;

FIG. 3 is a signaling diagram illustrating signaling between a DCAS headend and a set-top box according to an exemplary embodiment of the present invention; and

FIG. 4 is a flowchart illustrating a procedure for providing set-top box information in a set-top box identification method according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A Downloadable Conditional Access System (DCAS) is a system that is capable of providing a subscriber's terminal with the pay data and the data configured to be received by the subscriber among the received data. The DCAS includes a DCAS headend and a DCAS host.

The DCAS headend is responsible for downloading, updating, or deleting the Conditional Access System (CAS) information related to the pay data and the subscribed data. Here, the CAS information includes a password for the pay data, per-user download authentication information, and Secure Micro (SM) boot loader and CAS client information.

The DCAS host is connected to the DCAS headend through a gateway of the DCAS network and provides the user terminal with the received data in an appropriately converted format. Here, the description is made under the assumption that the DCAS host is a set-top box.

Set-top boxes can be classified into two categories, namely a satellite broadcast set-top box and a cable broadcast set-top box. The set-top boxes are implemented with different SM boot loader and CAS client depending on the manufacturer such that the coded data can be processed in different manners. The set-top box has a Secure Micro IDentifier (SM ID) for receiving data selectively, information on the SM boot loader for booting the system, and supportable CAS client and type information for identifying set-top boxes.

Exemplary embodiments of the present invention are described with reference to the accompanying drawings. The same reference numbers are used throughout the drawings to refer to the same or like parts. Detailed description of well-known functions and structures incorporated herein may be omitted to avoid obscuring the subject matter of the present invention.

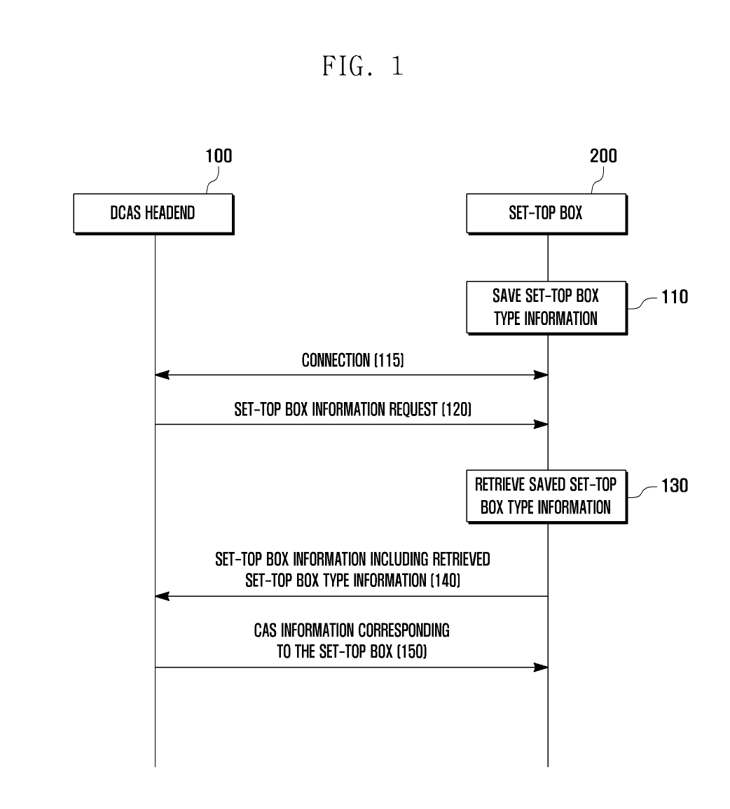

FIGS. 1 to 4, discussed herein, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a signaling diagram illustrating operations of entities of a DCAS according to an exemplary embodiment of the present invention.

Referring to FIG. 1, the DCAS includes a DCAS headend 100 and a DCAS set-top box 200.

In the manufacturing stage, the information on a type of the set-top box is stored in the set-top box in step 110, and this information can be configured by the user. The type of the set-top box information may include the set-top box vender, device model, and type of the set-top box which indicate compatibility on whether the set-top box is for satellite broadcast, for terrestrial broadcast, or for cable broadcast. The set-top box 200 can use the supportable broadcast data, methods for processing data, and decoding coded data depending on the manufacturer and device model. The DCAS headend 100 needs to provide correct CAS information that can be used in the corresponding set-top box such that the set-top box can operate appropriately.

The DCAS headend 100 and the set-top box 200 are connected with each other through a DCAS network in step 115. The DCAS headend 100 sends a request to the set-top box 200 to transmit set-top box information required for transmitting CAS information to be updated in step 120. If the set-top box information request is received, the set-top box 200 determines the set-top box type information that is previously stored in its storage in step 130. The set-top box 200 then transmits the set-top box type information to the DCAS headend 100 in step 140. Here, the set-top box information refers to the detailed information on the set-top box and includes the SM ID, version of the SM ID, status information on validity of the SM ID, and type of the set-top box. The set-top box type information includes the information on the manufacturer of the set-top box, device model, and type of the set-top box indicating whether the set-top box 200 can support satellite broadcast, terrestrial broadcast, and/or cable broadcast.

If the set-top box type information is received, the DCAS headend 100 determines the set-top box type information. The DCAS headend 100 then retrieves the CAS information appropriated for the set-top box corresponding to the identified set-top box type information.

Thereafter, the DCAS headend 100 transmits the retrieved CAS information corresponding to the set-top box 200 in step 150. Here, the CAS information includes the password set for the pay data, authentication information for data reception per user, and the information on the SM boot loader and CAS client.

A description is made of the DCAS headend 100 hereinafter.

The DCAS headend 100 may include a Local Key Server (LKS), an Authentication Proxy (AP), a Provisioning System (PS), and a DCAS Integrated Personalization Server.

The LKS stores reserved key information for troubleshooting, broadcast network identifier, authentication key, AP key, and PS key. The AP is responsible for providing messages for performing the DCAS function, generates session key for communication with the set-top box 200, and manages the communication with the set-top box. The AP can manage and maintain the CAS information, download policy and schedule information, request for the data purchase information and log information stored in the set-top box, and authenticate all the set-top boxes. The PS provides the CAS information for supporting CAS, Digital Rights Management (DRM), and Adaptive Software Development (ASD) functions. The PS decides and maintains the DCAS policy of the broadcast operator and distributes the DCAS download policy to the set-top boxes.

The DCAS headend 100 should know about the detailed information related to the set-top box in order to provide the set-top box 200 with correct CAS information. The DCAS headend 100 requests the set-top box 200 for the set-top box information and provides the set-top box 200 with the CAS information based on the set-top box information. The set-top box information includes the SM ID of the set-top box 200, information on the DRM supported by the set-top box 200, DRM information related to the ASD function, ASD information, set-top box manufacturer, device model, and type of the set-top box.

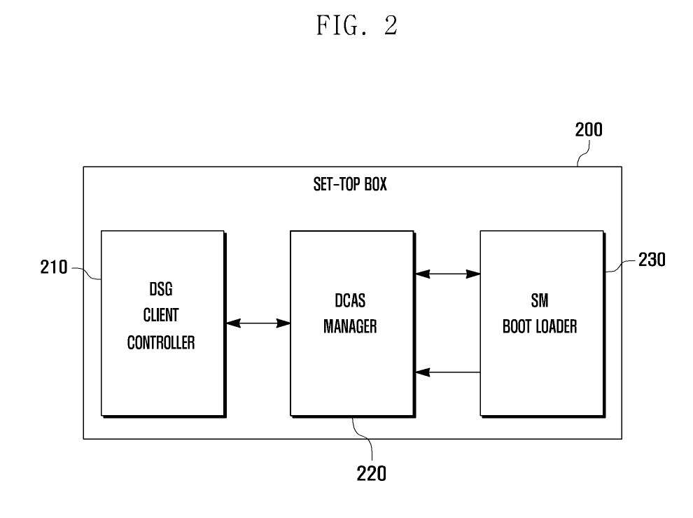

FIG. 2 is a block diagram illustrating a configuration of a set-top box according to an exemplary embodiment of the present invention.

Referring to FIG. 2, the set-top box 200 includes a Data Over Cable Service Interface Specification (DOCSIS) Set-top Gateway (DSG) client controller 210, a DCAS manager 220, and a SM boot loader 230.

The DSG client controller 210 is responsible for supplying the data received from the DCAS headend 100 to the DCAS manager. The DSG client controller also transmits the data provided by the DCAS manager 220 to the DCAS head end 100. Here, the DSG client controller 210 delivers the set-top box information request signal received from the DCAS headend 100 to the DCAS manager 220. The DSG client controller 210 also transmits the set-top box information provided by the DCAS manager 220 to the DCAS headend 100.

If the set-top box information request signal is received from the DCAS headend 100, the DCAS manager 220 requests the SM boot loader 230 for the set-top box information. The DCAS manager 220 obtains the set-top box information from the SM boot loader 230 and transmits the set-top box information to the DCAS headend 210.

While the set-top box is booting, the SM boot loader 230 initializes all the internal function blocks of the set-top box 200. The SM boot loader 230 calls the device drivers and programs that are basically needed for the operations of the set-top box 200. If the set-top box information request is received from the DCAS manager 220, the SM boot loader 230 provides the DCAS manager 220 with the previously saved set-top box information.

The set-top box information includes the detailed information on the set-top box such as SM ID as the subscriber authentication key, Transport Processor (TP) ID, SM version, SM status for indicating whether the authentication has been done, CAS client information, DRM information for controlling illegal data use, and set-top box type information. The set-top box type information can include at least one of a set-top box vender indicating set-top box manufacturer and a set-top box type indicating the device model that are saved in the manufacturing stage.

The set-top box information can be provided as shown in Table 1 according to an exemplary embodiment of the present invention.

TABLE 1

| Field Description | Note |
|---|---|
| ALDU Header | |
| DLDU Content { | |
| SM info. Field | |
| set top box Vendor | Information on the manufacturer of the set-top box |
| set top box Type | Model of the set-top box |
| } | |

Referring to Table 1, the set-top box information has an Adaptive Layer Data Unit (ALDU) Header, an SM information Field in DCAS Layer Data Unit (DLDU) Content element, wherein the SM information Field includes SM ID, TP ID, SM status, CAS client information, and DRM information. The SM information Field can further include the set-top box type information.

Once the set-top box information as shown in Table 1 is transmitted to the DCAS headend 100, the DCAS headend 100 retrieves the correct CAS information applicable to the set-top box 200 and sends the retrieved CAS information to the corresponding set-top box 200.

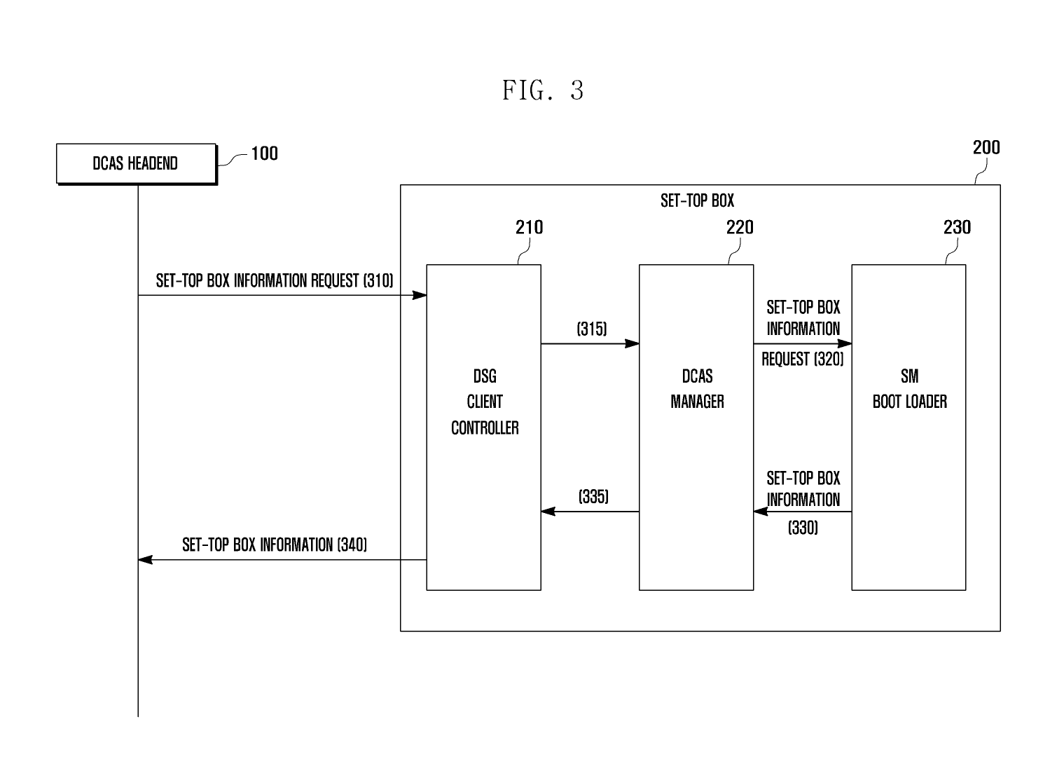

A description is made of the configuration of the set-top box and signaling between the set-top box and the DCAS headend 100 hereinafter with reference to FIG. 3.

FIG. 3 is a signaling diagram illustrating signaling between a DCAS headend and a set-top box according to an exemplary embodiment of the present invention.

Referring to FIG. 3, the DCAS headend 100 transmits a set-top box information request to the set-top box, the set-top box information being required for providing the set-top box with CAS information in step 310. If the set-top box information request is received, the DSG client controller 210 of the set-top box 200 delivers the set-top box information request to the DCAS manager 220 in step 315.

If the set-top box information request is received, the DCAS manager 220 requests the SM boot loader 230 for the set-top box information in step 320. Upon receipt of the set-top box information request, the SM boot loader 230 retrieves the previously saved set-top box information. Here, the set-top box information includes the information on the set-top box manufacturer, set-top box model, and set-top box type listed in Table 1 as well as the set-top box-related information such as SM ID, TP ID, and SM version.

The SM boot loader 230 provides the DCAS manager 200 with the retrieved set-top box information in step 330. Thereafter, the DCAS manager 220 delivers the set-top box information to the DSG client controller 210 in step 335. The DSG client controller 210 then transmits the set-top box information to the DCAS headend 100 in step 340.

Although not depicted in drawings, the DCAS headend 100 determines the detailed information related to the set-top box such as set-top box vendor and model and SM ID that are included in the set-top box information and determines the CAS information corresponding to the set-top box type information. The DCAS headend 100 transmits the CAS information corresponding to the set-top box type information to the set-top box 200. If the CAS information is received, the set-top box 200 processes the data authenticated with the received CAS information to the user.

A description is made of a procedure for providing set-top box information hereinafter.

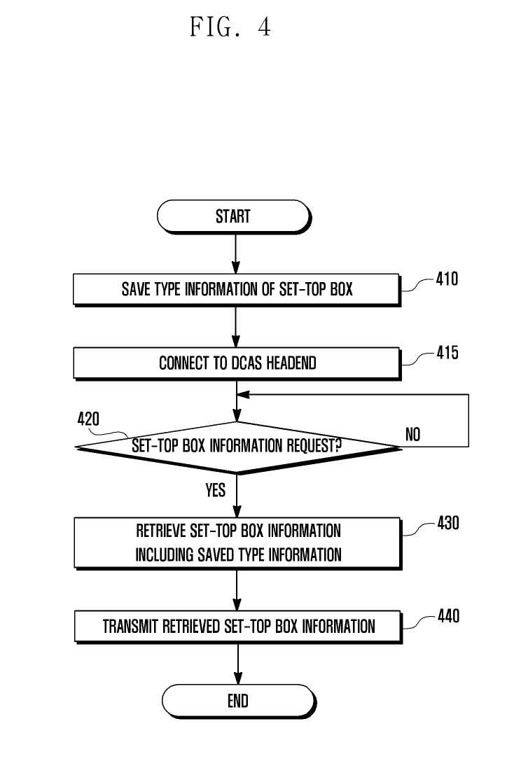

FIG. 4 is a flowchart illustrating a procedure for providing set-top box information in a set-top box identification method according to an exemplary embodiment of the present invention.

Referring to FIG. 4, the set-top box 200 stores the set-top box information including the set-top box type information in step 410. The set-top box type information can be configured by the set-top box manufacturer and include the vendor name, set-top box model, and set-top box type.

In step 415, the set-top box 200 accesses the DCAS headend 100 through a DCAS network. More particularly, if the set-top box 200 powers on, the set-top box 200 accesses the DCAS headend 100 to download the data selected by the user. The set-top box 200 processes the data to be output in form of a main screen on the user terminal, such as a television.

After establishing the connection to the DCAS headend 100, the set-top box 200 determines whether a set-top box information request is received from the DCAS headend 100 in step 420. If it is determined in step 420 that the set-top box information request is received, the set-top box 200 retrieves the previously saved set-top box information in step 430. Here, the set-top box information includes the information on the set-top box manufacturer, set-top box model, and set-top box type. Finally, the set-top box 200 transmits the retrieved set-top box information to the DCAS headend 100 in step 440.

Although not depicted in the drawings, in a case where no set-top box information request is received from the DCAS headend 100, the set-top box executes the function requested by the user. The set-top box 200 determines the authentication certificate with the DCAS headend 100 and the authenticated set-top box 200 is customized with an SM. Thereafter, the set-top box decodes the coded data received from the DCAS headend 100 and provides the decoded data to the user terminal.

As described above, the set-top box identification method and apparatus of exemplary embodiments of the present invention allow the DCAS headend to request for the information on the set-top box at any time so as to acquire the information on the set-top box manufacturer and model name and provide the set-top box with correct SM boot loader and CAS client based on the set-top box information, thereby preventing broadcast service failure to valid subscribers.

While the invention has been shown and described with reference to certain exemplary embodiments thereof, it will be understood by those skilled in the art that various changed may be made therein without departing from the spirit and scope of the invention as defined in the appended claims and their equivalents.

What is claimed is:

1. A method for identifying a set-top box in a Downloadable Conditional Access System (DCAS), the method comprising:
retrieving set-top box type information upon receipt of a set-top box information request transmitted by a DCAS headend;
transmitting the set-top box information including the set-top box type information to the DCAS headend; and
identifying, at the DCAS headend, the set-top box based on the set-top box information.

2. The method of claim 1, wherein the set-top box type information comprises at least one of a manufacturer, a model, and a type of the set-top box.

3. The method of claim 1, further comprising transmitting Conditional Access System (CAS) information corresponding to the set-top box type information from the DCAS headend to the set-top box.

4. The method of claim 3, wherein the CAS information comprises at least one of a password set for pay data, authentication information for data reception per user, and information on SM boot loader and CAS client.

5. The method of claim 1, wherein the set-top box information further comprises set-top box-related information including at least one of a Secure Micro Identifier (SM ID), a Transport Protocol Identifier (TP ID), and an SM version.

6. A set-top box identification system for a Downloadable Conditional Access System (DCAS), the system comprising:
a DCAS headend which requests set-top box information; and
a set-top box which retrieves the set-top box information and transmits the set-top box information including set-top box type information to the DCAS headend in response to the request from the DCAS.

7. The system of claim 6, wherein the set-top box type information comprises at least one of a manufacturer, a model, and a type of the set-top box.

8. The system of claim 6, wherein the DCAS headend transmits Conditional Access System (CAS) information corresponding to the set-top box type information to the set-top box.

9. The system of claim 8, wherein the CAS information comprises at least one of a password set for pay data, authentication information for data reception per user, and information on SM boot loader and CAS client.

10. The system of claim 6, wherein the set-top box information further comprises set-top box-related information including at least one of a Secure Micro Identifier (SM ID), a Transport Protocol Identifier (TP ID), and an SM version.
